(19) United States
(12) Patent Application Publication
(10) Pub. No.: US 2008/0079697 A1
(43) Pub. Date: Apr. 3, 2008

(54) DISPLAY DEVICE AND MANUFACTURING METHOD THEREOF

(76) Inventors: Dong-Ju Lee, Yongin-si (KR); Yeong-Koo Kim, Seoul (KR); Jeong-Min Cho, Hwaseong-si (KR); Jung-Soo Han, Seoul (KR); Jae-Kyoung Kim, Seoul (KR); Dong-Jin Jeong, Seoul (KR)

Correspondence Address: F. CHAU & ASSOCIATES, LLC, 130 WOODBURY ROAD, WOODBURY, NY, 11797, US

(21) Appl. No.: 11/832,170

(22) Filed: Aug. 1, 2007

(30) Foreign Application Priority Data
Aug. 1, 2006 (KR) 2006-0072544
May 15, 2007 (KR) 2007-0047222

(51) Int. Cl. G06F 3/041

(52) U.S. Cl. 345/173

(57) ABSTRACT

A display device and manufacturing method thereof suitable for providing a slim and lightweight display device with a low manufacturing cost includes a display panel having first and second substrates opposing each other, a first sensor electrode on the first substrate, a third substrate spaced apart from the first substrate, a second sensor electrode on a backside of a third substrate to come into contact with the first sensor electrode upon a user's touch, a contact electrode on each of the second and third substrates, and a short-circuit point between the contact electrodes on the second and third substrates to connect together the contact electrodes.

### CROSS REFERENCE TO RELATED APPLICATIONS

This application, claims priority from Korean Patent Applications Nos. 2006-72544 and 2007-47222, filed on Aug. 1, 2006 and May 15, 2007, respectively, in the Korean Intellectual Property Office, the disclosures of which are incorporated herein by reference in their entirety.

### BACKGROUND OF THE INVENTION

1. Technical Field

The present disclosure relates to a display device and manufacturing method thereof. Although the subject of the present disclosure is suitable for a wide scope of applications, it is particularly suitable for providing a slim and lightweight display device with a low manufacturing cost.

2. Discussion of Related Art

In display devices for displaying images, such as a cathode ray tube, a liquid crystal display device, a plasma display panel, and an electroluminescence display device, a touch panel has been used as an input device to input information on a screen of the display device. The touch panel for inputting information, which corresponds to a position on its surface pressed by a pressing means such as a pen or a user's finger, is attached to a front side of the display device.

In a display device provided with such a touch panel, if a user presses the touch panel using a pen or a finger, an analog coordinate signal for the corresponding position is supplied to a touch panel driver via a sensor electrode, a sensor line connected to the sensor electrode, and a touch panel circuit board connected to the sensor line to supply a sensor signal. The touch panel driver converts the inputted analog coordinate signal into a digital coordinate signal and then supplies the digital coordinate signal to a system.

The system generates a digital data signal corresponding to the digital coordinate signal and then supplies the generated signal to the touch panel driver. The digital data signal is supplied to a display driver via a liquid crystal panel circuit board. The digital data signal supplied to the display driver is converted into an analog data signal and then supplied to a signal line of the display device, whereby the display device implements an image for the pressed point of the touch panel.

The touch panel circuit board is attached to the touch panel, however, by a bonding process such as soldering and the like. In carrying out the touch panel circuit board connecting process, a contact part provided to the touch panel circuit board can be short-circuited or a soldering failure can take place, so that a contact failure can be generated.

Moreover, since the related art display device is provided with the touch panel circuit board and the display circuit board, two bonding processes are needed to attach the respective circuit boards, whereby the overall assembly process gets complicated.

Besides, the related art display device has difficulty in having its thickness and weight reduced due to the touch panel circuit board.

### SUMMARY OF THE INVENTION

Accordingly, exemplary embodiments of the present invention provide a display device and manufacturing method thereof, by which a signal is directly supplied to a touch panel from the display. An exemplary embodiment of the present invention provides a display device including a display panel having first and second substrates opposing each other, a first sensor electrode on the first substrate, a third substrate spaced apart from the first substrate, a second sensor electrode on a backside of the third substrate to contact the first sensor electrode by a user's touch, a sensor line connected to the first and second sensor electrodes, a contact electrode on each of the second and third substrates, and a short-circuit point between the contact electrodes on the second and third substrates to connect the contact electrodes together.

The display device further includes a touch panel driver receiving a coordinate signal for a position at which the first and second sensor electrodes are connected together.

The touch panel driver is loaded in a display panel driver for driving at least one of a gate line and a data line on the second substrate.

In this case, the display device further includes a plurality of signal lines connecting the contact electrodes to the driver.

The touch panel driver is loaded on a printed circuit board connected to the second substrate via a flexible circuit film.

The third substrate includes one selected from the group consisting of an optical film, a polarizing plate, and a glass substrate.

The short-circuit point includes a conductive metal-based material containing at least one selected from the group consisting of Au and Ag.

The display device further includes a spacer for maintaining a cell gap between the first and second sensor electrodes.

In an exemplary embodiment, the sensor line includes first and second sensor lines electrically connected to two sides opposing the first sensor electrode, respectively, third and fourth sensor lines electrically connected to the rest of the sides of the second sensor electrode not having the first and second sensor lines formed thereon, respectively, and first and second auxiliary sensor lines formed on the backside of the third substrate to be electrically connected to the first and second sensor lines, respectively.

The contact electrode on the second substrate includes first to fourth contact electrodes for supplying reference voltages to the first to fourth sensor lines, respectively, and the contact electrode on the third substrate includes fifth to eighth contact electrodes connected to the third and fourth sensor lines and one end portions of the first and second auxiliary sensor lines to correspond to the first to fourth contact electrodes, respectively.

In this case, the short-circuit point includes first to fourth short-circuit points electrically connecting the first to fourth contact electrodes to the fifth to eighth contact electrodes, respectively.

The sensor line includes first to fourth sensor lines electrically connected to the first sensor electrode of the first substrate and a fifth sensor line electrically connected to sides of the second sensor electrodes of the third substrate.

In an exemplary embodiment, the display device further includes first to fourth contact electrodes on the second substrate to supply reference voltages to the first to fourth sensor lines, respectively, fifth to eighth contact electrodes on the third substrate to correspond to the first to fourth contact electrodes, respectively, a ninth contact electrode on the second substrate to externally supply a sensor signal from the fifth sensor line, and a tenth contact electrode connected to the fifth sensor line of the third substrate to correspond to the ninth contact electrode.

In this case, the short-circuit point includes first to fourth short-circuit points electrically connecting the first to fourth contact electrodes to the fifth to eighth contact electrodes, respectively, and a fifth short-circuit point between the ninth and tenth contact electrodes to electrically connect them together.

The short-circuit point further includes sixth to ninth short-circuit points electrically connecting the fifth to eighth contact electrodes to the first to fourth sensor lines, respectively.

The display device further includes a linear pattern on the edges of the first sensor electrode to form an equal potential of the first sensor electrode.

An exemplary embodiment of the present invention provides a method of manufacturing a display device including forming at least one contact electrode on a second substrate of a display panel having the second substrate and a first substrate opposing the second substrate, forming a first sensor electrode on the first substrate, forming a second sensor electrode on a backside of a third substrate opposing the first substrate, forming a sensor line electrically connected to the first and second sensor electrodes of the first and third substrates, forming a contact electrode on the third substrate to be electrically connected to the sensor line of the backside of the third substrate, the contact electrode being configured to correspond to the contact electrode of the second substrate, and forming a short-circuit point connecting together the corresponding contact electrodes of the second and third substrates.

The sensor line forming step includes forming first and second sensor lines on two opposed sides of the first sensor electrode of the first substrate, respectively, forming first and second auxiliary sensor lines on the third substrate to correspond to the first and second sensor lines, respectively, and forming third and fourth sensor lines on the rest of the sides of the second sensor electrode, except for the two opposed sides having the first and second auxiliary sensor lines formed thereon.

After the steps of forming the first and second sensor electrodes, the method further includes forming a spacer for maintaining a cell gap between the first and second sensor electrodes.

The sensor line forming step includes forming first to fourth sensor lines connected to the first sensor electrode and forming a fifth sensor line connected to the second sensor line.

The fifth sensor line forming step further includes forming the fifth sensor line along a periphery of the second sensor electrode to configure one closed loop.

After the first sensor electrode forming step, the method further includes forming a linear pattern for equal potential of the first sensor electrode.

It is to be understood that both the foregoing general description and the following detailed description of the present invention are exemplary and explanatory and are intended to provide further explanation of the invention as claimed.

### BRIEF DESCRIPTION OF THE DRAWINGS

Exemplary embodiments of the present invention will be understood in more detail from the following descriptions taken in conjunction with the accompanying drawings. In the drawings:

FIG. 1 is an exploded perspective diagram of a display device according to an exemplary embodiment of the present invention;

FIG. 2 is a layout of a display panel of the display device shown in FIG. 1;

FIG. 3 is a layout of a third substrate for a touch panel of the display device shown in FIG. 1;

FIGS. 4 to 6 are layouts of a display device according to a respective touch panel driver mounted position;

FIG. 7 is a cross-sectional diagram of the display device shown in FIG. 1 taken along line I-I′;

FIG. 8 is a cross-sectional diagram of the display shown in FIG. 1 taken along line II-II′;

FIG. 9 is a cross-sectional diagram of a touch panel having been pressed;

FIG. 10 is a cross-sectional diagram of a display device according to an exemplary embodiment of the present invention;

FIG. 11 is a flowchart of an exemplary embodiment of a method of manufacturing the display device shown in FIG. 1;

FIG. 12 is an exploded perspective diagram of a display device according to an exemplary embodiment of the present invention;

FIG. 13 is a layout of a display panel of the display device shown in FIG. 12;

FIG. 14 is a layout of a third substrate of the display device shown in FIG. 12; and

FIG. 15 is a flowchart of an exemplary embodiment of a method of manufacturing the display device shown in FIG. 12.

### DETAILED DESCRIPTION OF EXEMPLARY EMBODIMENTS

Reference will now be made in detail to the exemplary embodiments of the present invention, examples of which are illustrated in the accompanying drawings. Wherever possible, the same reference numbers will be used throughout the drawings to refer to the same or like parts.

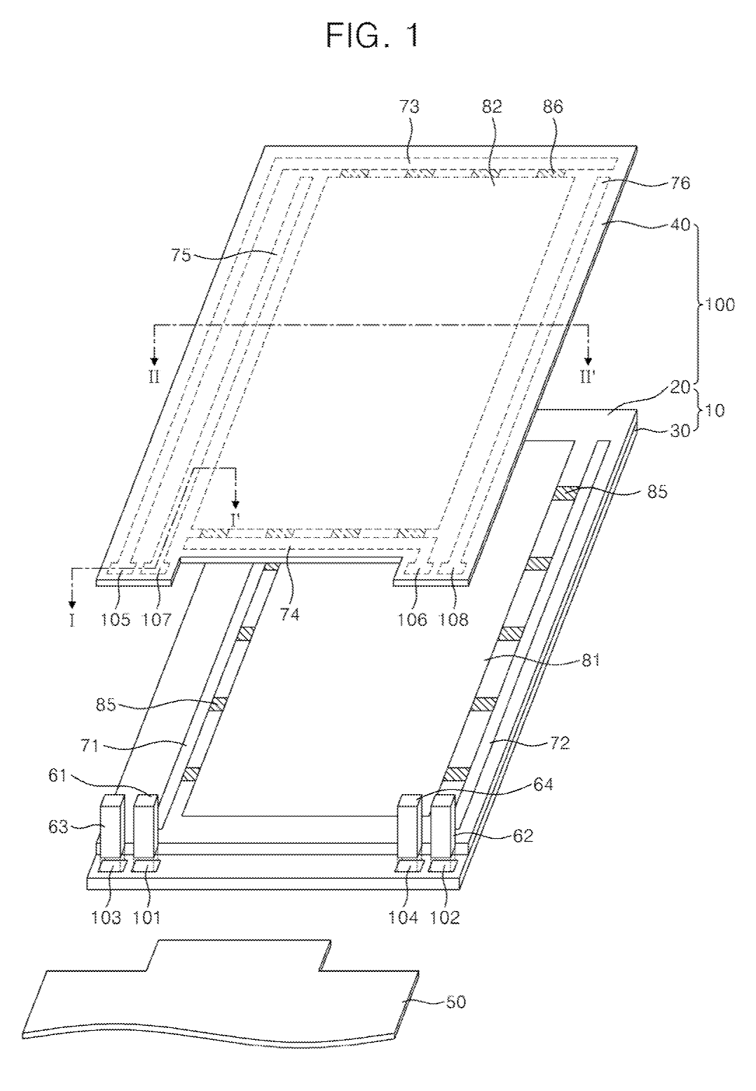

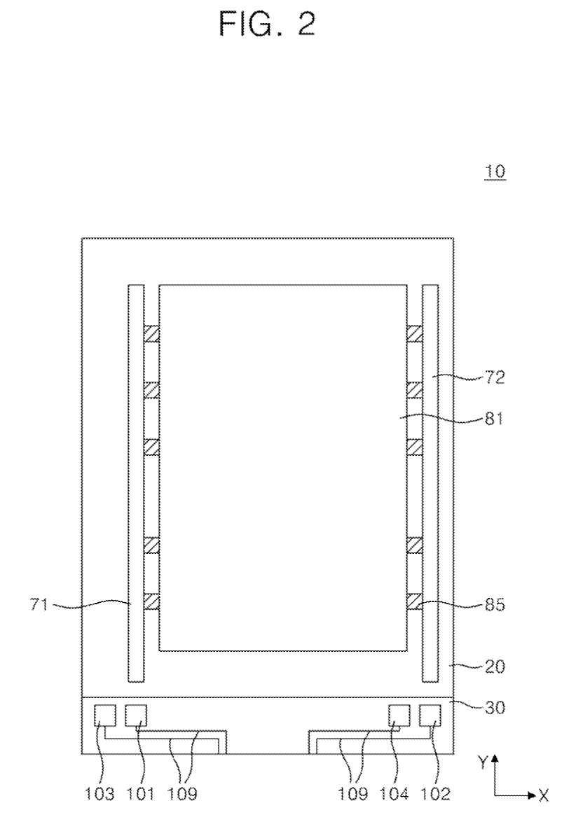

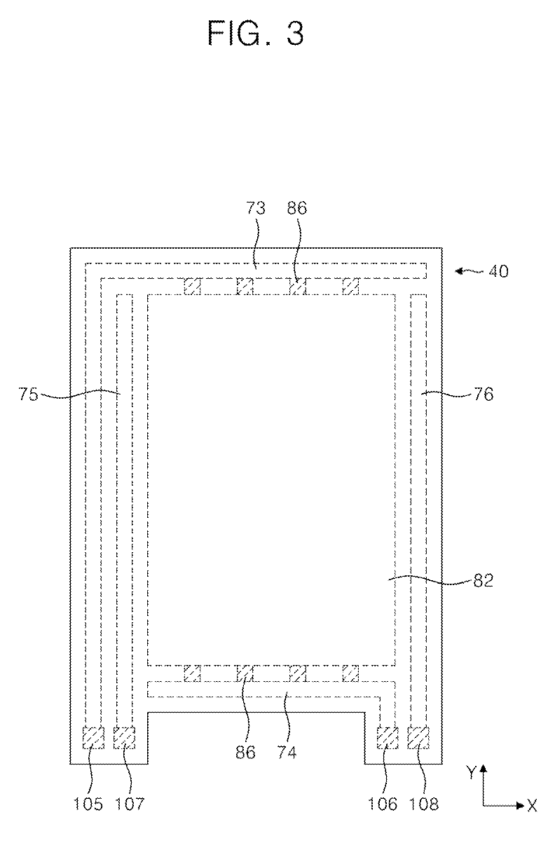

FIG. 1 is an exploded perspective diagram of a display device according to an exemplary embodiment of the present invention, FIG. 2 is a layout of a display panel of the display device shown in FIG. 1, and FIG. 3 is a layout of a third substrate for a touch panel of the display device shown in FIG. 1.

Referring to FIGS. 1 to 3, a display device includes a display panel 10 for displaying an image, a touch panel 100 provided over the display panel 10, and a flexible circuit film 50 supplying a driving signal and a sensor signal to the display panel 10 and the touch panel 100, respectively.

More specifically, a liquid crystal panel including a first substrate 20, a second substrate 30 bonded to the first substrate 20, and liquid crystals inserted between the first and second substrates 20 and 30 is described as an example of the display panel 10.

A color filter (not shown) is provided to a backside of the first substrate 20, and the first substrate 20 includes a common electrode opposing a pixel electrode to generate an electric field. The first substrate 20 may further include a black matrix (not shown) for preventing light leakage.

The second substrate 30 includes a thin film transistor (“TFT”) array (not shown). The thin film transistor array includes a gate line, a data line crossing with the gate line to leave a gate insulating layer in-between, a TFT provided to a pixel area defined by the gate and data lines crossing with each other to be connected to the gate line and the data line, and a pixel electrode connected to the TFT.

The second substrate 30 is provided with first to fourth contact electrodes 101, 102, 103, and 104 to supply a reference voltage to a third substrate 40. The first to fourth contact electrodes 101, 102, 103, and 104 are evenly distributed to both corner areas of a lower end portion of the second substrate 30. The first to fourth contact electrodes 101, 102, 103, and 104 are formed by the same process for forming the TFT array of the second substrate 30. Four signal lines 109 are further formed to be connected to the first to fourth contact electrodes 101, 102, 103, and 104, respectively.

The four signal lines 109 apply a reference voltage supplied from an external touch panel controller (not shown in the drawings) to the first to fourth contact electrodes 101, 102, 103, and 104 and also apply a sensor signal detected from the touch panel 100 to a touch panel driver (not shown in the drawings).

The touch panel 100 is fabricated by bonding the third substrate 40 to the first substrate 20 of the display panel 10.

The touch panel 100 includes a first sensor electrode 81 provided to a topside of the first substrate 20, a second sensor electrode 82 provided to a backside of the third substrate 40, first and second sensor lines 71 and 72 provided to both sides of the first sensor electrode 81, respectively, and third and fourth sensor lines 73 and 74 provided to both sides of the second sensor electrode 82, respectively.

In this case, the first sensor electrode 81 is provided to oppose a display area of the display panel 10.

The first and second sensor lines 71 and 72 are configured to oppose each other by having the first sensor electrode 81 in-between. The first and second sensor lines 71 and 72, as shown in FIG. 2, are floated in a direction of the Y-axis. Alternatively, the first and second sensor lines 71 and 72 stay be configured in the direction of the X-axis. The first and second sensor lines 71 and 72 are configured to be directly contacted with left and right sides of the first sensor electrode 81, respectively. Alternatively, the first and second sensor lines 71 and 72 are configured to be stacked on the left and right sides of the first sensor electrode 81, respectively. Alternatively, the first and second sensor lines 71 and 72 may be connected to the left and right sides of the first sensor electrode 81 via first connecting electrodes 85 electrically connecting each of the first and second sensor lines 71 and 72 to the first sensor electrode 81.

In this case, a plurality of the first connecting electrodes 85 are provided between the first sensor electrode 81 and each of the first and second sensor lines 71 and 72. The first connecting electrodes 35 are formed of the same metal as the first sensor lines 71 and 72 or the first sensor electrode 81.

The second sensor electrode 82 and the third and fourth sensor lines 73 and 74, which are provided to the upper and lower sides of the second sensor electrode 82 to be supplied within the reference voltage, respectively, are provided to the backside of the third substrate 40. The backside of the third substrate 40 is provided with first and second auxiliary sensor lines 75 and 76 (shown in phantom) to be electrically connected to the first and second sensor lines 71 and 72, respectively. The third substrate 40 includes fifth and sixth contact electrodes 105 and 106 respectively provided to end portions of the third and fourth sensor lines 73 and 14 and seventh and eighth contact electrodes 107 and 108 respectively provided to end portions of the first and second auxiliary sensor lines 75 and 76.

The third substrate 40 includes a transparent substrate such as a transparent film, a polarising plate, a glass substrate, and the like. The second sensor electrode 82 is formed on a backside of the transparent substrate.

The second sensor electrode 82 is configured to oppose the first sensor electrode 81.

Each of the third and fourth sensor lines 73 and 74 is configured to be electrically connected to the second sensor electrode 82. The third and fourth sensor lines 73 and 74 are provided in directions perpendicular to the first and second sensor lines 71 and 72, respectively.

The third sensor line 73 is provided in the vicinity of an upper side of the second sensor electrode 82 in a direction along the X-axis, while the fourth sensor line 74 is provided in the vicinity of a lower side of the second sensor electrode 82 in the direction along the X-axis.

In this case, to be electrically connected to the second sensor electrode 82, the third and fourth sensor lines 73 and 74 are configured to be directly contacted with the upper and lower sides of the second sensor electrode 82, respectively, stacked on the second sensor electrode 82, or connected to the second sensor electrode 82 via a second connecting electrode 86 (shown in phantom). In an exemplary embodiment of the present invention, it is assumed that each of the third and fourth sensor lines 73 and 74 is electrically connected to the second sensor electrode 82 via the second connecting electrode 86.

The second connecting electrode 86 electrically connects the upper side of the second sensor electrode 82 to the third sensor line 73. The second connecting electrode 86 also electrically connects the lower side of the sensor electrode 82 to the fourth sensor line 74. The second connecting electrode 86 is formed of the same material as one of the third sensor line 73, the fourth sensor line 74, and the second sensor electrode 82. Generally, a plurality of the connecting electrodes 86 is provided.

The fifth contact electrode 105 is provided at one end portion of the third sensor line 73 and is provided at a lower left corner area of the third substrate 40, as shown in FIG. 1.

The sixth contact electrode 106 is provided at one end portion of the fourth sensor line 74 and is provided at a lower right corner area of the third substrate 40, as shown in FIG. 1.

Alternatively, both the fifth and sixth contact electrodes 105 and 106 are formed on the same corner area of the third substrate 40.

The first auxiliary sensor line 75 is provided to correspond to the first sensor line 71 shown in FIG. 2, and the second auxiliary sensor line 76 is provided to correspond to the second sensor line 72. The first and second auxiliary sensor lines 75 and 76 are formed of the same conductive material as the third and fourth sensor lines 73 and 74.

The seventh and eighth contact electrode 107 and 108 are provided at one end portions of the first and second auxiliary sensor lines 75 and 76, respectively.

The seventh and eighth contact electrodes 107 and 108 are advantageously formed to be electrically disconnected from the fifth and sixth contact electrodes 105 and 106, respectively. The seventh and eighth contact electrodes 107 and 108 are provided at left and right corners of the third substrate 40, respectively. Alternatively, both the seventh and eighth contact electrodes 107 and 108 may be provided at one corner area of one side of the third substrate 40.

The above-described fifth to eighth contact electrodes 105, 106, 107, and 108 are electrically connected to the first to fourth short-circuit points 61, 62, 63, and 64, respectively.

The flexible circuit film 50 is attached to one side of the display panel 10, supplies a panel driving signal to the display panel 10, and supplies a reference voltage to the touch panel 100. The reference voltage supplied from the touch panel driver is supplied to at least one of the first to fourth short-circuit points 61, 62, 63, and 64 via the signal lines provided to the display panel 10. The flexible circuit film 50 supplies a sensor signal from the touch panel 100 to the touch panel driver. The sensor signal supplied from the touch panel 100 is then supplied to the touch panel driver via one of the rest of the first to fourth short-circuit points 61, 62, 63, and 64.

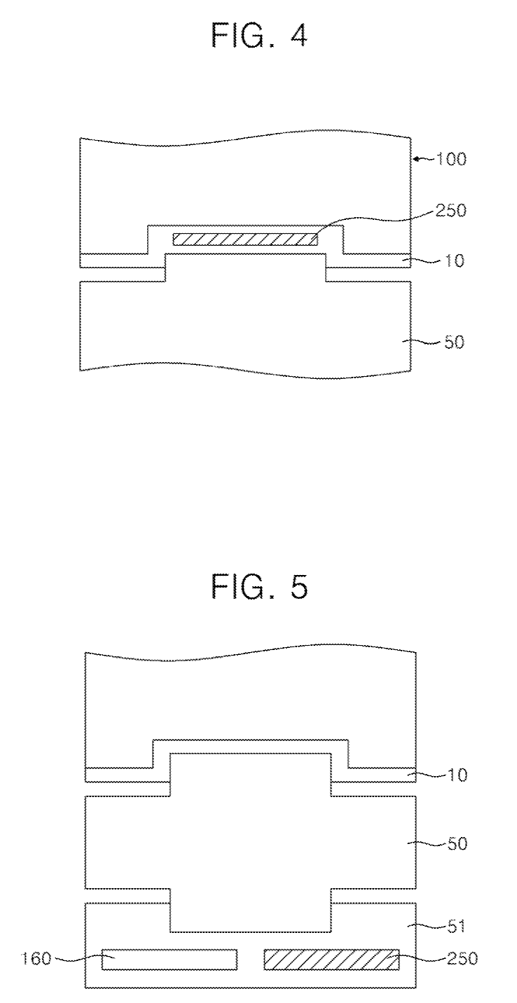

FIGS. 4 to 6 are layouts of a display device according to a touch panel driver mounting position, respectively.

Referring to FIG. 4, a touch panel driver 250 is loaded on a display panel 10. The touch panel driver 250 is connected to the signal lines 109 respectively connected to the short-circuit points 61, 62, 63, and 64 shown in FIG. 3 to supply a reference voltage to a touch panel 100 and detects a sensor signal from the touch panel 100.

Alternatively, the touch panel driver 250, as shown in FIG. 5, can be loaded on a printed circuit board 51. More specifically, the touch panel driver 250 is loaded on the printed circuit board 51 having a display panel driver 160 for driving the display panel 10. The printed circuit board 51 is electrically connected to the display panel 10 via the flexible circuit film 50.

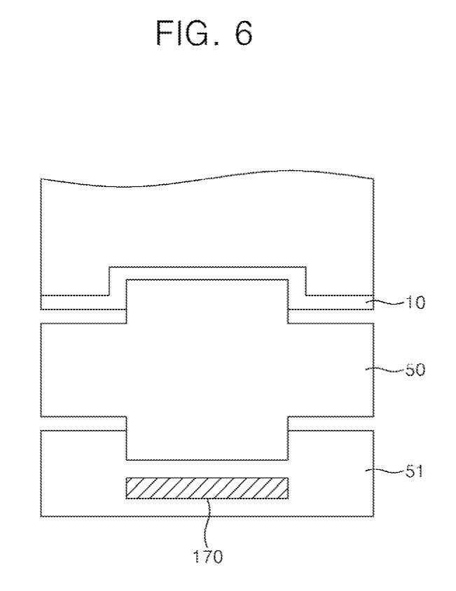

Alternatively, as shown in FIG. 6, the touch panel driver can be included within a display panel driver 170 for driving the display panel 10 and then loaded on the display panel 10. The display panel driver 170 having the touch panel driver included therein is mounted on a printed circuit board 51. Alternatively, the display panel driver 170 having the touch panel driver included therein may be loaded directly on the display panel 10.

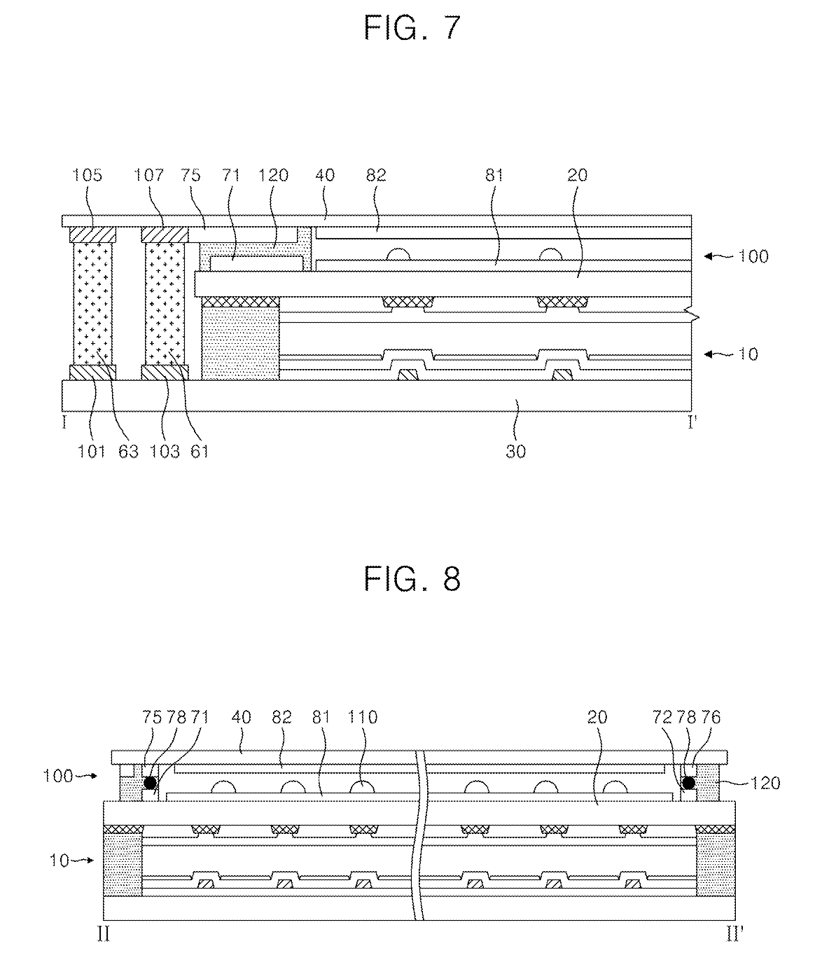

FIG. 7 is a cross-sectional diagram of the display device shown in FIG. 1 taken along line I-I′.

Referring to FIG. 7, the first and third substrates 20 and 40 are bonded together by an adhesive agent 120. The adhesive agent 120 is provided at an edge area of the first substrate 20. The adhesive agent 120 is formed to overlap an area including the first to fourth sensor lines 71, 72, 73, and 74 and the first and second auxiliary sensor lines 75 and 76.

The first short-circuit point 61 connects the first and seventh contact electrodes 101 and 107 provided on the second substrate 30, while the third short-circuit point 63 connects the third and fifth contact electrodes 103 and 105. The second short-circuit point (62, not shown in FIG. 7) connects the second and eighth contact electrodes (not shown) in FIG. 7) between the second and third substrates 30 and 40. The fourth short-circuit point (64, not shown in FIG. 7) connects the fourth and sixth contact electrodes (104, 106, not shown in FIG. 7).

FIG. 8 is a cross-sectional diagram of the display device shown in FIG. 1 along line II-II′.

Referring to FIG. 8, the display device includes auxiliary short-circuit points 78 connecting the first and second sensor lines 71 and 72 to the first and second auxiliary sensor lines 75 and 76, respectively.

The auxiliary short-circuit points 78 connect the first and second sensor lines 71 and 72 provided to the first substrate 20 to the first and second auxiliary sensor lines 75 and 76 provided to the third substrate 40, respectively. Thus, the reference voltages supplied to the first and second auxiliary sensor lines 75 and 76 are supplied to the first and the second sensor lines 71 and 72 via the auxiliary short-circuit points 78, respectively. A plurality of the auxiliary short-circuit points 78 can be provided between the first sensor line 71 and the first auxiliary sensor line 75. A plurality of the auxiliary short-circuit points 78 can also be provided between the second sensor line 72 and the second auxiliary sensor line 76.

The touch panel 100, as shown in FIG. 8, further includes spacers 110 for maintaining a cell gap between the first and second sensor electrodes 81 and 82.

The spacers 110 are provided distributed over the first sensor electrode 81. On the other hand, the spacers 110 can alternatively foe provided on the second sensor electrode 82.

When the first and second sensor electrodes 81 and 82 are actuated by the second sensor electrode 82 being pressed by a user, the spacer 110 enables a gap between the pressed portions to be maintained. Preferably, a height of the spacer 110 is formed to be smaller than the gap between the first and second sensor electrodes 81 and 82. The spacer 110 is formed of a transparent insulating material. Preferably, the spacer 110 is formed of a UV-hardening material, a thermal-hardening material, or the like.

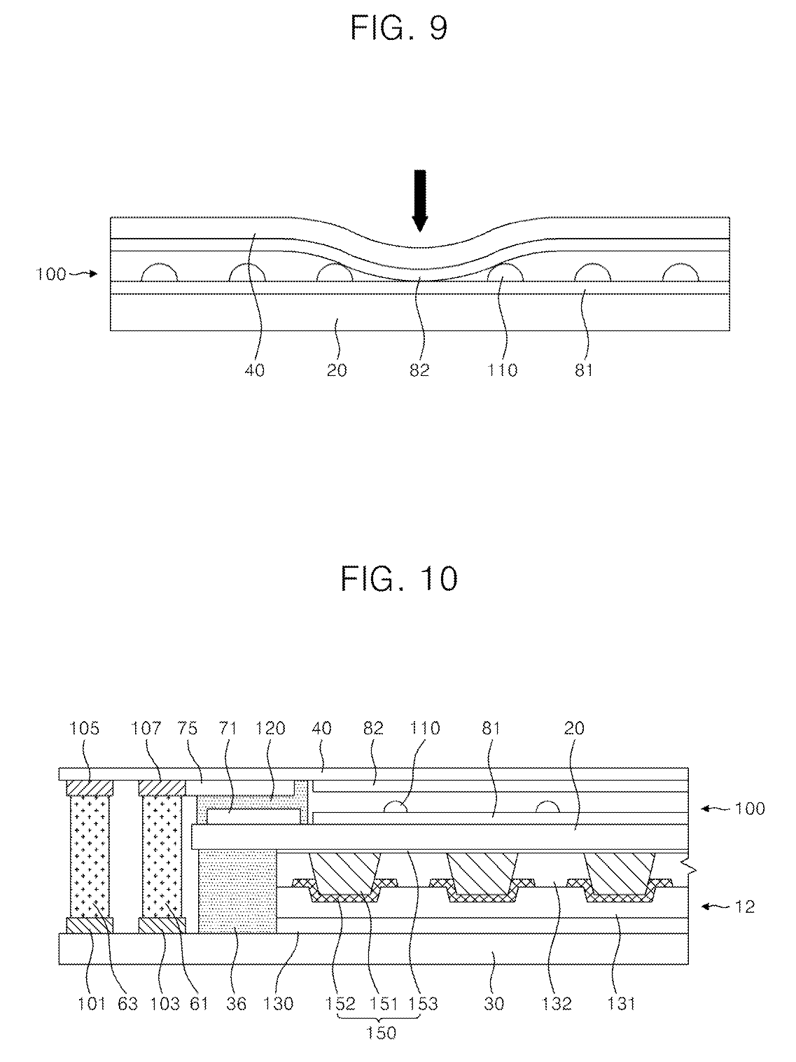

Referring to FIG. 9, if the third substrate 40 is pressed so as to be deformed, the spacer 110 appropriately adjusts a contact size between the first sensor electrode 81 of the first substrate 20 and the second sensor electrode 82 of the third substrate 40. The spacers 110 are spaced apart from, each other so as to enable the first and second sensor electrodes 81 and 82 to contact each other when the third substrate 40 is pressed by a user. Preferably, the interval between the spacers 110 is adjusted so as not to increase the contact distance between the first and second sensor electrodes 81 and 82 excessively.

FIG. 10 is a cross-sectional diagram of a display device according to an exemplary embodiment of the present invention.

FIG. 10 shows the same elements of the cross-sectional diagram shown in FIG. 1 along line I-I′ except that the display panel is an organic electroluminescence (“EL”) display panel. Therefore, details of the same elements will be omitted in the following description.

Referring to FIG. 10, an organic EL display panel 12 includes a first substrate 20 and a second substrate 30. First and second sensor lines 71 and 72, which are electrically connected to first and second sensor electrodes 81 and 82 to supply a reference voltage thereto, respectively, are formed on the first substrate 20. The first substrate 20 is sealed to the second substrate 30, and a TFT array 130 and an organic light emitting diode 150 are formed on the second substrate 30.

The TFT array 130 includes a gate line (not shown), a data line (not shown) configured to cross with the gate line, an organic light emitting diode 150 provided to each pixel area between the gate and data lines crossing with each other, and a power line (not shown) for supplying a current to the light emitting diode 150. The TFT array 130 includes switching and driving transistors (not shown) for controlling the organic light emitting diode 150 and a storage capacitor (not shown) for charging a data voltage supplied to the switching transistor.

The organic light emitting diode 150 is formed on a planarizing layer 131 provided onto the TFT array 130. The organic light emitting diode 150 includes an anode electrode 152 connected to the power line (not shown), a cathode electrode 153 supplied with a voltage lower than the voltage supplied via the power line, and an organic light-emitting layer 151 provided between the anode and cathode electrodes 152 and 153 to emit light, in this case, the organic light-emitting layer is embedded in an area enclosed by a partition wall 132.

The second substrate 30 includes the first and third contact electrodes 101 and 103 explained in the foregoing description of FIG. 1, and the second substrate 30 includes second and fourth contact electrodes (not shown in FIG. 10).

To protect the above-described second substrate 30 and the organic light-emitting layer 151 on the second substrate 30 against moisture, the second substrate 30 is sealed to the first substrate 20. A sealing material 36 is provided between the first and second substrates 20 and 30 to provide an air-tight seal.

The organic EL display panel 12 emits light in a direction of the first substrate 20. For instance, the first substrate 20 is formed of a transparent material and includes one of a glass substrate, a thin, plastic substrate, and the like. Optionally, a transparent moisture absorbent layer may be further provided to a bottom side of the first substrate 20.

The first sensor electrode 81, the first sensor line 71 and the second sensor line 72 are formed on the first substrate 20.

The third substrate 40 is configured to oppose the first substrate 20 and to be the outermost layer. The third substrate 40 is formed as a transparent substrate. On the transparent substrate, a second sensor electrode 82, a third sensor line 73, a fifth contact electrode 105 on one end portion of the third sensor line 73, a first auxiliary sensor line 75 and a seventh contact electrode 107 on one end portion of the first auxiliary sensor line 75 are formed. The third substrate 40 includes a fourth sensor line connected to the second sensor electrode 82, a sixth contact electrode on one end portion of the fourth sensor line, a second auxiliary sensor line, and an eighth contact electrode on one end portion of the second auxiliary sensor line (not shown in FIG. 10).

The first and third substrate 20 and 40 are bonded together by the adhesive agent 120 to configure a touch panel 100. First and third short-circuit points 61 and 63 are included to electrically connect the first and fifth contact electrodes 101 and 105 on the second substrate 30 to the third and seventh contact electrodes 103 and 107, respectively. The first short-circuit point 61 connects the first contact electrode 101 and the seventh contact electrode 107 together, and the third short-circuit point 63 connects the third contact electrode 103 and the fifth contact electrode 105 together. Like the first and third short-circuit points 61 and 63, the second short-circuit point (not shown in FIG. 10) connects the second contact electrode 102 shown in FIG. 1 to the eighth contact electrode 108 and the fourth short-circuit point connects the third and sixth contact electrodes 103 and 106 together. Each of the first to fourth short-circuit points is formed of a conductive metal-based material including one of Au, Ag, and the like.

A spacer 110 is further formed on the first sensor electrode 31 to maintain a cell gap between the first and second sensor electrodes 81 and 82. An auxiliary short-circuit point, shown at 78 in FIG. 8, is provided between the first/second sensor line 71/72 and the first/second auxiliary sensor line 75/76 to connect the first/second sensor line 71/72 to the first/second auxiliary sensor line 75/76.

The display device described in FIGS. 1 to 10 detects coordinates of a position at which a touch is made, via the reference voltage supplied from the touch panel driver 250.

More specifically, the first sensor electrode 81 provided to the touch panel 100 has a predetermined potential with equal intervals by the reference voltages of different potentials respectively applied to the first and second sensor lines 71 and 72. Like the first sensor electrode 81, the second sensor electrode 82 also has a predetermined potential at equal intervals by the reference voltages of different potentials respectively applied to the third and fourth sensor lines 73 and 74.

If a touch is made to a random spot of the touch panel 100, reference voltages are applied to the first and second sensor lines 71 and 72 for detection of an X-axis coordinate, respectively. The touch panel driver (not shown in detail in the drawings) supplies the reference voltages differing from each other in potential via the first and second short-circuit points 61 and 62. Subsequently, the reference voltages applied to the first and second short-circuit points 61 and 62 are applied to the first and second auxiliary sensor lines 75 and 76 connected to the seventh and eighth contact electrodes 107 and 108, respectively. The applied reference voltages are then supplied to the first and second sensor lines 71 and 72 connected to the first and second auxiliary sensor lines 75 and 76 via the auxiliary short-circuit points 78, respectively. Finally, the X-axis coordinate is detected in a manner of supplying the potential at the touched spot of the first sensor electrode 81 via the reference voltages supplied to the first and second sensor lines 71 and 72 to the touch panel driver, shown at 250 in FIGS. 4 and 5, via the second sensor electrode 33 and one of the third and fourth sensor lines 73 and 74.

Subsequently, the touch panel driver 250 supplies different reference voltages via the third and fourth contact electrodes 103 and 104, respectively. The reference voltages applied via the third and fourth contact electrodes 103 and 104 are applied to the third and fourth sensor lines 73 and 74 connected to the fifth and sixth contact electrodes 105 and 106 via the third and fourth short-circuit points 63 and 64, respectively. Finally, a Y-axis coordinate is detected in a manner of supplying the potential detected by the second sensor electrode 82 to the touch panel driver 250 via the first sensor electrode 81 and one of the first and second sensor lines 71 and 72.

The touch panel driver 250 then calculates the coordinates of the touched spot by combining the detected coordinates.

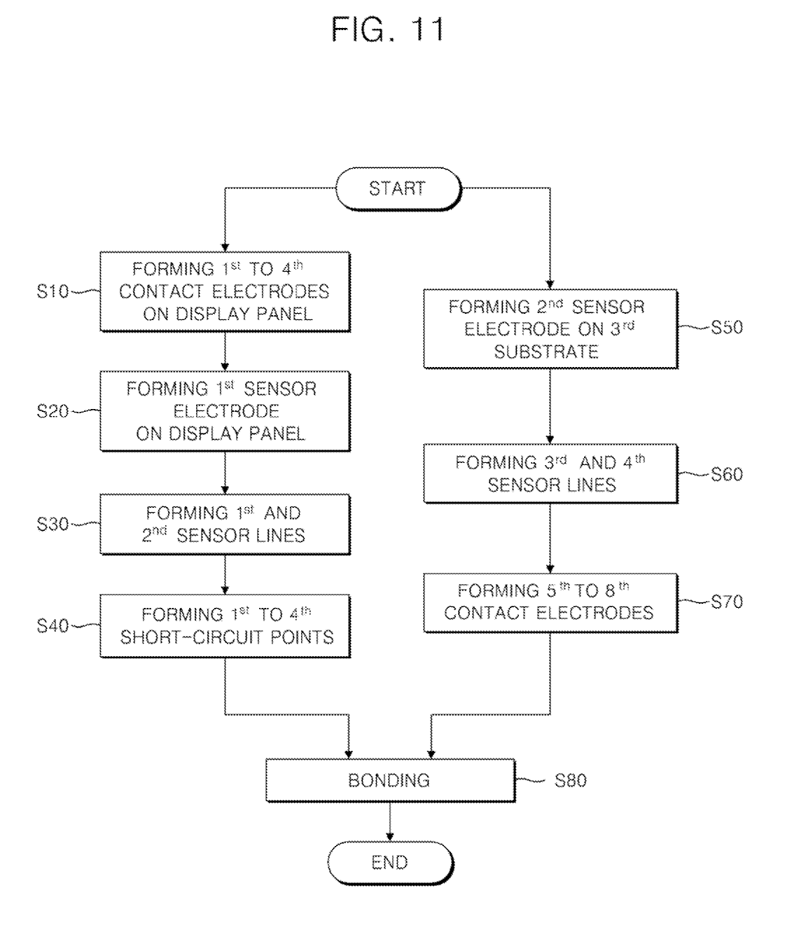

FIG. 11 is a flowchart of an exemplary embodiment of a method of manufacturing the display device shown in FIG. 1, which is explained with reference to the same reference numbers for the same elements associated with FIGS. 1 to 10.

Referring to FIG. 11, a method of manufacturing a display device includes step S10 of forming first to fourth contact electrodes on a display panel, step S20 of forming a first sensor electrode on the display panel, step S30 of forming first and second sensor lines, step S40 of forming first to fourth short-circuit points, step S50 of forming a second sensor electrode on a third substrate, step S60 of forming third and fourth sensor lines, step 370 of forming fifth to eighth contact electrodes, and step S80 of bonding the first and third substrates together.

In the step S10 of forming first to fourth contact electrodes on a display panel, the first to fourth contact electrodes 101, 102, 103, and 104 are formed on the second substrate 30 of the display panel 10. The display panel 10 is provided by bonding the first substrate 20 and the second substrate 20 together using the seal line 35. The first to fourth contact electrodes 101, 102, 103, and 104 can be simultaneously formed when the TFT array of the second substrate 30 is formed. The first to fourth contact electrodes 101, 102, 103, and 104 are provided to a lower side of the second substrate 30 and, more particularly, to an externally exposed area of the second substrate 30 having been bonded to the first substrate 20. The first and third contact electrodes 101 and 103 are provided to the left part of the second substrate 30 and the second and fourth contact electrodes 102 and 104 are provided to the right part of the second substrate 30.

In the step S20 of forming a first sensor electrode on the display panel, a first sensor electrode 81 is formed on a topside of the first substrate 20 using a transparent conductive material, such as ITO (indium tin oxide), IZO (indium zinc oxide), ITZO (indium tin zinc oxide), and the like. The first sensor electrode 81 is formed on the topside of the first substrate by one of printing, sputtering, and the like.

In the step S30 of forming first and second sensor lines, the first and second sensor lines 71 and 72 are formed on the first substrate 20 to be electrically connected to the first sensor electrode 81. The first and second sensor lines 71 and 72 are formed on both sides of the first sensor electrode 81 in a direction along the Y-axis. Alternatively, the first and second sensor lines 71 and 72 can be formed in a direction along the X-axis. The first and second sensor lines 71 and 72 are formed by one of printing, sputtering, and the like. Each of the first and second sensor lines 71 and 72 is formed of a material having a small internal resistance, for example, Au, Ag, or Cu.

The first connecting electrode 85 can be further formed to connect together the first sensor electrode 81 and each of the first and second sensor lines 71 and 72. For instance, in the case that the first and second sensor lines 71 and 72 are formed so as to float instead of being connected to both lateral sides of the first sensor electrode 81, the first sensor electrode 81 is electrically connected to each of the first and second sensor lines 71 and 72 via the first connecting electrode 85. At least one first connecting electrode 85 is provided between the first sensor electrode 81 and the first sensor line 71. At least one first connecting electrode 85 is also provided between the first sensor electrode 81 and the second sensor line 72. The first connecting electrode 85 is formed by one of printing and sputtering. The first connecting electrode 85 is formed of the same material as the first sensor electrode 81 or the first or second sensor line 71 or 72 or another conductive metal-based material. Considering contact resistance and the like, it is preferable that the first connecting electrode 85 is formed of the same material as the first sensor electrode 81 or the first or second sensor line 71 or 72. The first connecting electrode 85 can be simultaneously formed when the step of forming the first sensor electrode 81 or the step of forming the first and second sensor lines 71 and 72 is carried out.

In the step 340 of forming first to fourth short-circuit points, the first to fourth short-circuit points 61, 62, 63, and 64 are formed on the first to fourth contact electrodes 101 to 104, respectively. Preferably, the first to fourth short-circuit points 61, 62, 63, and 64 are formed using a metal having a small internal resistance and a high conductivity, such as Ag, Au, or an alloy thereof.

In the step of forming the first to fourth short-circuit points, the auxiliary short-circuit points 78 can be formed on the first and second sensor lines 71 and 72, respectively. The auxiliary short-circuit points are formed of the same metal material of each of the first to fourth short-circuit points 61, 62, 63, and 64.

Subsequently, a third substrate is prepared to configure a touch panel on the display panel. A polarizing plate or a transparent thin film is used as the third substrate. To farm a touch panel on the third substrate, a process that is different from the steps of forming the display panel is carried out.

In particular, in the step S50 of forming a second sensor electrode on a third substrate, a second sensor electrode 82 is formed on a backside of the third substrate 40 to oppose the first sensor electrode 81. Like the first sensor electrode 81, the second sensor electrode 82 is formed of a transparent conductive material, such as ITO (iridium tin oxide), IZO (indium zinc oxide), or ITZO (indium tin zinc oxide), The second sensor electrode 82 is formed by the same method of forming the first sensor electrode 81.

In the step S60 of forming third and fourth sensor lines, the third and fourth sensor lines 73 and 74 are formed on the upper and lower sides of the second sensor electrode 82, respectively. The third and fourth sensor lines 73 and 74 are formed on the backside of the third substrate 40 to be electrically connected to the second sensor electrode 82. In this case, the third and fourth sensor lines 73 and 74 are formed in a direction perpendicular to that of the first and second sensor lines 71 and 72, that is, in an X-axis direction. If the first and second sensor lines 71 and 72 are formed in a direction along the X-axis, the third and fourth sensor lines 73 and 74 are formed in a direction along the Y-axis. The third and fourth sensor lines 73 and 74 are formed of the same metal as the first and second sensor lines 71 and 72. The third and fourth sensor lines 73 and 74 are formed of a metal-based material having a small internal resistance, such as Ag, Au, or Cu.

When the third and fourth sensor lines 73 and 74 are formed, the first and second auxiliary sensor lines 75 and 76 are formed. The first and second auxiliary sensor lines 75 and 76 are formed to correspond to the first and second sensor lines 71 and 72, respectively. The first and second auxiliary sensor lines 75 and 76 are formed of the same metal based material as the third and fourth sensor lines 73 and 74. The first and second auxiliary sensor lines 75 and 7 are formed so as to be insulated from the third and fourth sensor lines 73 and 74, respectively.

A second connecting electrode 86 can be further formed to connect the second sensor electrode 82 to each of the third and fourth sensor lines 73 and 74. The second connecting electrode is formed by the same method as in forming the first connecting electrode 85, the details of which will be omitted in the following description.

In the step S70 of forming fifth to eighth contact electrodes, the fifth and sixth contact electrodes 105 and 106 are formed at one end portions of the third and fourth sensor lines 73 and 74 on the backside of the third substrate, respectively. The fifth and sixth contact electrodes 105 and 106 are formed on corner areas of a lower side of the third substrate 40, respectively. Since the fifth contact electrode 105 is formed on one end portion of the third sensor line 73, the third sensor line 73 is configured to extend along a periphery of the third substrate 40 in a direction along the Y-axis to be connected to the fifth contact electrode 103.

When the fifth and sixth contact electrodes 105 and 106 are formed, the seventh and eighth contact electrodes 107 and 108 are formed to be connected to end portions of the first and second auxiliary sensor lines 75 and 76, respectively. The seventh and eighth contact electrodes 107 and 108 are formed to be insulated from the fifth and sixth contact electrodes 105 and 106, respectively. The fifth to eighth contact electrodes 105, 106, 107, and 108 can be formed of the same material and process used for forming the third and fourth sensor lines 73 and 74 and the first and second auxiliary sensor lines 75 and 76.

In the step S80 of bonding the first and third substrates together, an adhesive agent is provided to one of the first and third substrates 20 and 40. The first and third substrates 20 and 40 are aligned and then bonded together. Preferably, the adhesive agent 120 is provided to overlap the area including the first to fourth sensor lines 71, 72, 73, and 74. By the bonding step, the first to fourth short-circuit points 61 to 64 electrically connect the first to fourth contact electrodes 101, 102, 103, and 104 to the fifth to eighth contact electrodes 105, 106, 107, and 108, respectively.

A step of forming the spacer 110 on the first or second sensor electrode 81 or 82 can be further included. More specifically, by forming the spacer 110 of a transparent insulating material, a cell gap between the first and second sensor electrodes 81 and 32 can be maintained.

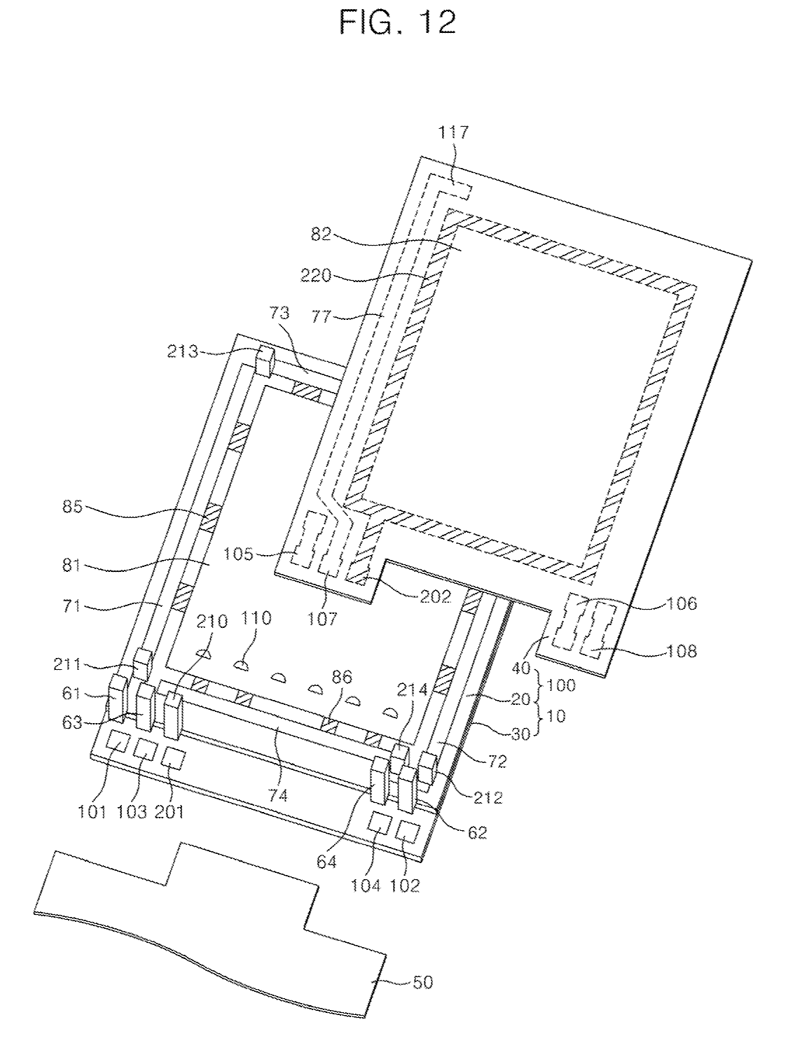

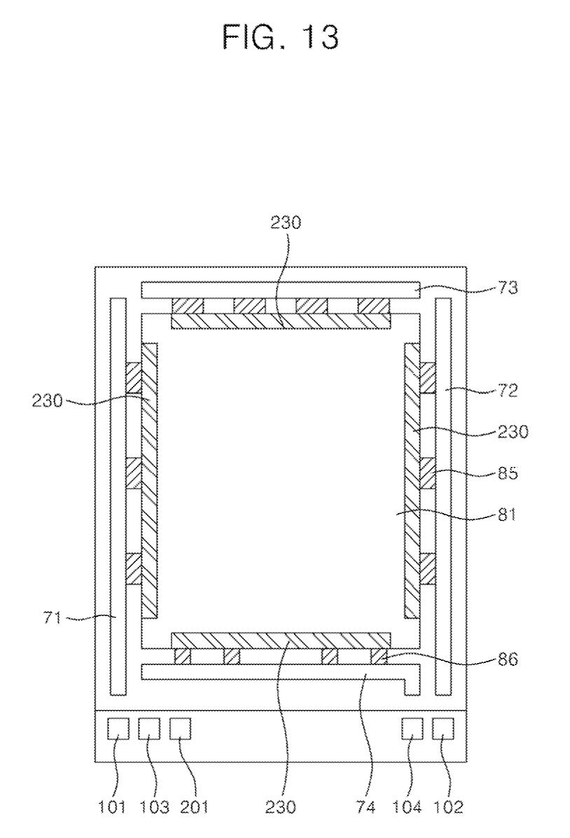

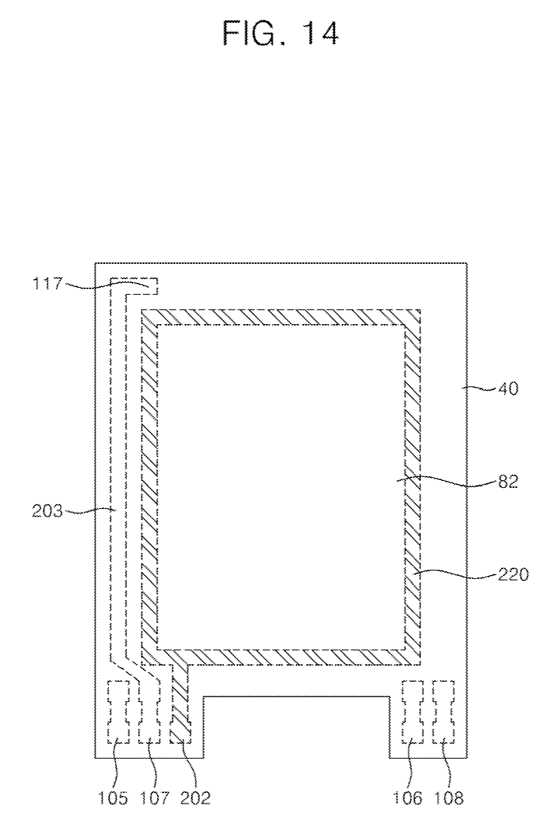

FIG. 12 is an exploded perspective diagram of a display device according to an exemplary embodiment of the present invention; FIG. 13 is a layout of a display panel of the display shown in FIG. 12; and FIG. 14 is a layout of a third substrate of the display device shown in FIG. 12.

Referring to FIGS. 12 to 14, a display device includes a display panel 10, a touch panel 100 on the display panel 10, and a flexible circuit film 50 attached to the display panel 10. The flexible circuit film 50 is the same as the flexible circuit film 50 previously shown in FIG. 1, and details of the flexible circuit film are omitted in the following description.

A ninth contact electrode 201 is provided to a second substrate 30 of the display panel 10 to apply a sensor signal detected by the touch panel 100 to the second substrate 30. The ninth contact electrode 201, as shown in FIG. 12, is provided at a corner area of a left lower side of the second substrate 30. Alternatively, the ninth contact electrode 201 can be provided at a corner area of a right lower side of the second substrate 30.

The touch panel 100 includes a first sensor electrode 81 and first to fourth sensor lines 71, 72, 73, and 74 respectively connected to the first sensor electrode 81, which are formed on a first substrate 20 over the display panel 10. The touch panel 100 also includes a second sensor electrode 82 and a fifth sensor line 220 electrically connected to the second sensor electrode 82, which are formed on a backside of a third substrate 40. First to fourth short-circuit points 61, 62, 63, and 64 for supplying reference voltages to the first to fourth sensor lines 71, 72, 73, and 74 respectively and a fifth short-circuit point 210 for supplying a sensor signal from the fifth sensor line 220 to the flexible circuit film 50 are further included.

The first sensor electrode 81 is formed of a transparent conductive material such as ITO (indium tin oxide), IZO (indium zinc oxide), or ITZO (indium tin zinc oxide). The first to fourth sensor lines 71, 72, 73, and 74 are formed next to the four sides of the first sensor electrode 81.

Each of the first to fourth sensor lines 71, 72, 73, and 74 is formed of a metal-based material having a low specific resistance, such as Ag or Au. Each of the first to fourth sensor lines 71, 72, 73, and 74 is electrically connected to the first sensor electrode 81. Each of the first to fourth sensor lines 71, 72, 73, and 74 is configured to be directly contacted with the first sensor electrode 81 or to be electrically connected to the fist sensor electrode 81 via a first connecting electrode 85. Preferably, the first connecting electrode 85 is formed of the same material as one of the first to fourth sensor lines 71, 72, 73, and 74 and the first sensor electrode 81.

The first and second sensor lines 71 and 72 are provided at opposite sides of the first sensor electrode 81 in a direction along the Y-axis, respectively.

The third and fourth sensor lines 73 and 74 are provided at opposite sides of the first sensor electrode 81 in a direction along the X-axis, respectively. The third and fourth sensor lines 73 and 74 are configured to foe directly contacted with upper and lower sides of the first sensor electrode 81, respectively. Alternatively, the third and fourth sensor lines 73 and 74 can be configured to be stacked on the upper and lower sides of the first sensor electrode 81, respectively. Alternatively, the third and fourth sensor lines 73 and 74 can be electrically connected to the first sensor electrode 81 via a second connecting electrode 86.

A linear pattern 230 can be further provided on the first substrate 20 to be electrically connected to the first sensor electrode 81. The linear pattern 230, as shown in FIG. 13, is formed on the first sensor electrode 81 along each side edge of the first sensor electrode 81.

If a reference voltage is applied from the first sensor line 71 provided next to the left side of the sensor electrode 81, the linear pattern 230 generates an equal potential on the left side of the first sensor electrode 81. If a reference voltage is applied from the second sensor line 72 provided next to the right side of the sensor electrode 81, the linear pattern 230 generates the same potential on the right side of the first sensor electrode 81. Thus, if the reference voltages are supplied to the first and second sensor lines 71 and 72, the linear pattern 81 equalizes potentials of positions equally distant from one of the sides of the first sensor electrode 81.

For the reference voltages applied to the third and fourth sensor lines 73 and 74, the linear pattern 230 equalizes potentials equally distant from one of the upper and lower sides of the first sensor electrode 81.

The second electrode 82 is provided to oppose the first sensor electrode 81, and the second sensor electrode 82 is formed of a transparent conductive material.

The fifth sensor line 220 is configured to be electrically connected to the second sensor electrode 82. The fifth sensor line 220 is configured as a closed loop running along the four sides of the second sensor electrode 82. The fifth sensor line 220 can be stacked on the edges of the second sensor electrode 82. The fifth sensor line 220 detects a sensor signal from the second sensor electrode 82.

Fifth to eighth contact electrodes 105, 106, 107, and 108 are further provided to the backside of the third substrate 40 to correspond to the first to fourth contact electrodes 101, 102, 103, and 104, respectively.

Each of the fifth to eighth contact electrodes 105, 106, 107, and 108 is formed of a conductive material such as Ag, Au, and Ag—Au alloy. The fifth to eighth contact electrodes 105, 106, 107, and 108 are provided at corner areas of both sides of the third substrate 40. The fifth and seventh contact electrodes 105 and 107 are provided at a corner area of a left side, and the sixth and eighth contact electrodes 106 and 108 are provided at a corner area of a right side. Alternatively, the fifth and seventh contact electrodes 105 and 107 are provided at a corner area of a right side and the sixth and eighth contact electrodes 106 and 108 are provided at a corner area of a left side. Alternatively, the fifth and sixth contact electrodes 105 and 106 are provided at a corner area of one of the left and right sides and the seventh and eighth contact electrodes 107 and 108 are provided at the other corner area.

The seventh contact electrode 107 is connected to an auxiliary sensor line 77 for supplying a reference voltage to the third sensor line 73. The auxiliary sensor line 77 is configured to extend along the left side of the second sensor electrode 82. Alternatively, the auxiliary sensor line 77 is configured to extend along the right side of the second sensor electrode 82.

A tenth contact electrode 202 is configured to be connected to the fifth sensor line 220. The tenth contact electrode 202 is provided at a corner area of one of the sides of the third substrate 40 to correspond to the ninth contact electrode 201 shown in FIG. 12. The tenth contact electrode 202 is formed of the same metal-based material as the fifth sensor line 220.

The first to fourth short-circuit points 61, 62, 63, and 64 electrically connect the first to fourth contact electrodes 101, 102, 103, and 104 of the second substrate 30 to the fifth to eighth contact electrodes 105, 106, 107, and 108 of the third substrate 40, respectively. The fifth short-circuit point 210 electrically connects the ninth contact electrode 201 of the second substrate 30 to the tenth contact electrode 202 of the third substrate 40. Thus a sensor signal from the fifth sensor line 210 is supplied to the flexible circuit film 50 via the second substrate 30. Each of the first to fourth short-circuit points 61, 62, 63, and 64 is formed of a conductive material, such as Au, Ag, or the like.

The display device includes sixth to ninth short-circuit points 211, 212, 213, and 214 connecting the first to fourth sensor lines 71, 72, 73, and 74 of the first substrate 20 to the first to fourth contact electrodes 101, 102, 103, and 104, respectively. The sixth short-circuit point 211 electrically connects together the fifth contact electrode 105 and the first sensor line 71. The seventh short-circuit point 212 electrically connects together the sixth contact electrode 106 and the second sensor line 72. The eighth short-circuit point 213 electrically connects one end portion 117 of the auxiliary sensor line 77 to the third sensor line 73. The ninth short-circuit point 214 electrically connects together the eighth contact electrode 103 and the fourth sensor line 74.

Via the sixth to ninth short-circuit points 211, 212, 213, and 214, reference voltages applied to the third substrate 40 are supplied to the first to fourth sensor lines 71, 72, 73, and 74, respectively.

The touch panel 100, as shown in FIG. 12, includes a spacer 100 to maintain a cell gap between the first and second sensor electrodes 81 and 82.

The spacer 110 is provided to either the first or second sensor electrode 81 or 82 and the spacer 110 is formed of a transparent insulating material.

Unlike what is shown in FIG. 12, positions of the first to fourth sensor lines 71, 72, 73, and 74 and a position of the fifth sensor line 220 can be interchanged. The first to fourth sensor lines 71, 72, 73, and 74 are provided to the third substrate 40 and the fifth sensor line 220 is provided to the first substrate 20. In this case, the sixth to ninth short-circuit points 211, 212, 213, and 214 can be omitted. On the other hand, the third substrate 40 is deformed by a user's touch, so as to generate cracks in the second sensor electrode 82 so that touch sensitivity may be degraded. The first to fourth sensor lines 71, 72, 73, and 74 are provided to the first substrate 20 and the fifth sensor line 220 is provided to the third substrate 40.

When the touch panel 100 is touched, the second sensor electrode 82 comes into contact with the first sensor electrode 81. When that happens, an external touch panel controller (not shown in the drawings) recognizes the touch of the first and second sensors 81 and 82 and then applies a reference voltage for measuring an X- or Y-axis coordinate to the first sensor electrode 81. In the case of applying the reference voltage to the first sensor electrode 81, the reference voltage is not applied to the third and fourth sensor lines 73 and 74 while the reference voltage is applied to the first and second sensor lines 71 and 72. To recognize the X-axis coordinate, the reference voltage is applied via the first and second sensor lines 71 and 72, a potential at a touched spot of the first sensor electrode is recognized by the second sensor electrode 82, the recognized potential is then delivered to the touch panel driver via the fifth sensor line 220.

The Y-axis coordinate can be recognized in the same manner as the above description relative to the X-axis coordinate.

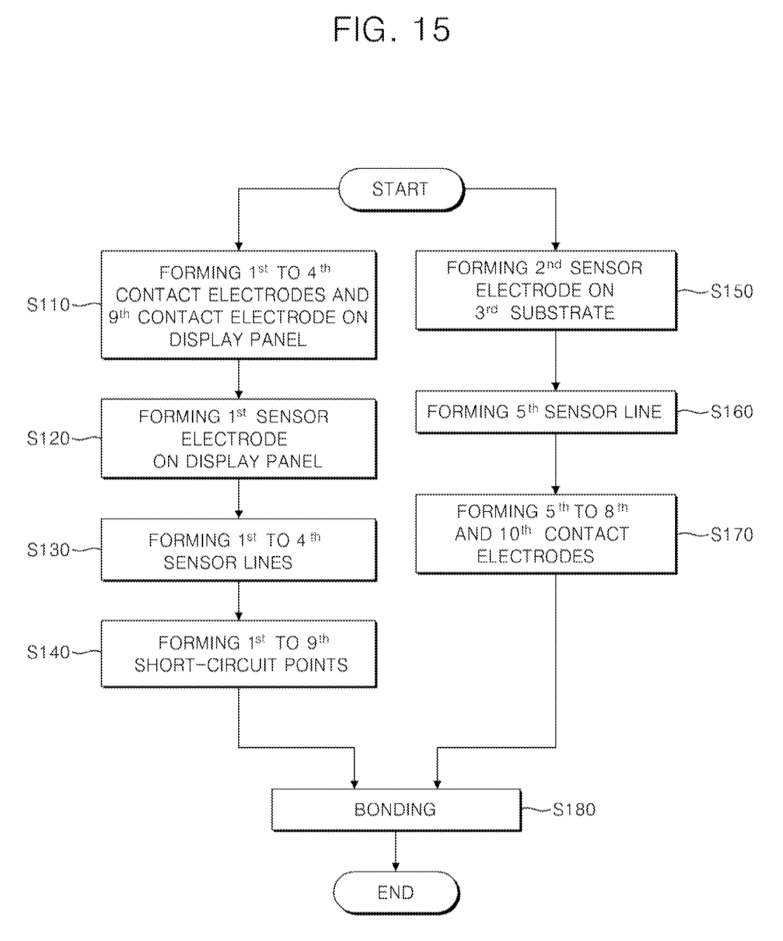

FIG. 15 is a flowchart of a method of manufacturing the display device shown in FIG. 12 according to an exemplary embodiment of the present invention.

Referring to FIG. 15, a method of manufacturing a display device includes step S110 of forming first to fourth contact electrodes and a ninth contact electrode on a second substrate, step S120 of forming a first sensor electrode on a first substrate, step S130 of forming first to fourth sensor lines on the first substrate, step S140 of forming short-circuit points, step S150 of forming a fifth sensor line on a third substrate, step S160 of forming a second sensor electrode on the third substrate, step S170 of forming fifth to eighth contact electrodes and a tenth, electrode on the third substrate, and step S180 of bonding the first and third substrates together.

In the step S110 of forming first to fourth contact electrodes and a ninth contact electrode on a second substrate, first to fourth contact electrodes 101, 102, 103, and 104 and a ninth contact electrode 201 are formed on a second substrate 30 of a display panel 10. The display panel 10 includes one of a liquid crystal panel and an organic electroluminescence panel. The first to fourth contact electrodes 101, 102, 103, and 104 are formed by the step of forming a TFT array of the second substrate 30 to reduce the process time and manufacturing cost. The first to fourth contact electrodes 101, 102, 103, and 104 are formed on the opposite corner areas that do not overlap the first substrate 20, respectively. The ninth contact electrode 201 is formed on one of both corner areas of the second substrate 30 with the same material and by the same process for forming the first to fourth contact electrodes 101, 102, 103, and 104.

In the step S120 of forming a first sensor electrode on a first substrate, a first sensor electrode 81 is formed on the first substrate 20 by one of printing, screen printing, and the like. The first sensor electrode 81 is formed of a transparent conductive material such as ITO (indium tin oxide), IZO (indium zinc oxide), ITZO (indium tin zinc oxide), and the like.

A linear pattern 230 can be further formed on the first sensor electrode 81 and the linear pattern 230 is formed along the edges of the first sensor electrode 81.

In the step S130 of forming first to fourth sensor lines on the first substrate, first to fourth sensor lines 71, 72, 73, and 74 are formed on the first substrate 20 to be electrically connected to the first sensor electrode 81. The first to fourth sensor lines 71, 72, 73, and 74 are formed by one of printing, sputtering, and the like. Each of the first to fourth sensor lines 71, 72, 73, and 74 is formed of a material having a low internal resistance, such as Au, Ag, Cu, and the like.

The first and second sensor lines 71 and 72 among the first to fourth sensor lines 71, 72, 73, and 74 are formed in a direction along the Y-axis of the first substrate 20 and the third and fourth sensor lines 73 and 74 are formed in a direction along the X-axis. In the case that each of the first to fourth sensor lines 71, 72, 73, and 74 is floated, a step of forming first and second connecting electrodes 85 and 86 and connecting the floated sensor lines to the first sensor electrode 81 is further included.

The first and second connecting electrodes 85 and 86 are formed of the same material in the same process as the first sensor electrode 81 or are formed of the same material in the same process for forming the first to fourth sensor lines 71, 72, 73, and 74.

In the step 3140 of forming short-circuit points, first to fourth short-circuit points 61, 62, 63, and 64 are formed at the first to fourth contact electrodes 101, 102, 103, and 104, respectively and a fifth short-circuit point 210 is formed at the ninth contact electrode 201. Sixth to ninth short-circuit points 211, 212, 213, and 214 are formed on the first to fourth sensor lines 71, 72, 73, and 74, respectively. Each of the first to ninth short-circuit points 61, 62, 63, and 64 and 212, 213, and 214 is formed of a conductive material, such as Ag, An, or an alloy thereof.

A method of fabricating a third substrate of a touch panel is explained as follows.

in the step S150 of forming a fifth sensor line on a third substrate, a second sensor electrode 82 is formed on a backside of a third substrate 40. Like the first sensor electrode 81, the second sensor electrode 82 is formed by one of printing, sputtering, and the like using a transparent conductive material, such as ITO (indium tin oxide), IZO (indium zinc oxide), ITZO (indium tin zinc oxide), and the like.

In the step S160 of forming a second sensor electrode on the third substrate, a fifth sensor line 220 is formed on the backside of the third substrate 40 to be connected to the second sensor electrode 82. The fifth sensor line 220 is formed of a metal-based material having low resistance, such as Ag, Au, or Cu. In this case, the fifth sensor line 220 is formed along a periphery of the second sensor electrode 82. Optionally, a step of forming a connecting electrode for connecting together the fifth sensor line 220 and the second sensor electrode 82 may be further included.

In the step S170 of forming the fifth to eighth contact electrodes and a tenth electrode on the third substrate, the fifth to eighth contact electrodes 105, 106, 107, and 108 are formed on the backside of the third substrate 40 to correspond to the first to fourth contact electrodes 101, 102, 103, and 104, respectively. Ends of the fifth to eighth contact electrodes 105, 106, 107, and 108 are configured to foe symmetric with the first to fourth contact electrodes 101, 102, 103, and 104, respectively. The other ends of the fifth, sixth and eighth contact electrodes 105, 106, and 108 are configured to overlap the first, second and fourth sensor lines 71, 72 and 74, respectively. An auxiliary sensor line 77 connected to the other end of the seventh contact electrode 107 is further formed. An end portion of the auxiliary sensor line 77 is configured to overlap at least the third sensor line 73.

The tenth contact electrode 202 is formed to be electrically connected to the fifth sensor line 220 and corresponds to the ninth contact electrode 201.

The fifth to eighth contact electrodes 105, 106, 107, and 108, the tenth contact electrode 202, and the auxiliary sensor line 77 are formed on the backside of the third substrate 40 using a metal based material having a small internal resistance, such as Ag, Au, or Cu. The fifth to eighth contact electrodes 104, 105, 106, 107, and 108 are formed to be floated from each other, and the tenth contact electrode 202 is formed to be electrically connected to the fifth sensor line 220. The fifth to eighth contact electrodes 104, 105, 106, 107, and 103 can be formed by one of printing and sputtering.

The fifth to eighth contact electrodes 105, 106, 107, and 108 and the tenth contact electrode 202 may be simultaneously formed by the step S160 of forming the fifth sensor line.

In the step S180 of bonding the first and third substrates together, an adhesive agent is formed on the edges of the first substrate 20. The first and second substrates 20 and 40 are aligned and then bonded together to complete a touch panel. The first to fourth short-circuit points 61, 62, 63, and 64 electrically connect the first to fourth contact electrodes 101, 102, 103, and 104 to ends of the fifth to eighth contact electrodes 105, 106, 107, and 108, respectively. Likewise, the fifth short-circuit point 210 electrically connects the ninth contact electrode 201 to the tenth contact electrode 202.

Alternatively, a step of forming a spacer on either the first sensor electrode 81 or the second sensor electrode 82 may be further included. In such a spacer forming step, a transparent insulating material is evenly distributed on the first or second sensor electrode 81 or 32 to maintain a cell gap between the first and second sensor electrodes 81 and 82. The spacer forming step can be carried out before or after one of the steps S120, S150, S130, S160, and S140.

Accordingly, exemplary embodiments of the present invention provide the following effects and advantages.

First of ail, a sensor signal supplied to a touch panel is supplied directly to a display panel circuit board so as to omit a touch panel circuit board. Hence, exemplary embodiments of the present invention are able to reduce material and process costs.

Secondly, because the touch panel circuit board can be omitted, a slim and lightweight display device can be provided.

It will be apparent to those of ordinary skill in the art that various modifications and variations can be made in the exemplary embodiments of the present invention without departing from the spirit or scope thereof. Thus, it is intended that the present invention covers the modifications and variations of this invention provided they come within the scope of the appended claims and their equivalents.

What is claimed is:

1. A display device comprising:
a display panel having first and second substrates opposing each other;
a first sensor electrode on the first substrate;
a third substrate spaced apart from the first substrate;
a second sensor electrode formed on the third substrate and facing with the first sensor electrode to contact the first sensor electrode by action of a user's touch;
a sensor line connected to the first and second sensor electrodes;
a contact electrode formed on each of the second and third substrates and electrically connected to the sensor line; and
a short-circuit point between the contact electrodes on the second and third substrates so as to connect together the contact electrodes.

2. The display device of claim 1, further comprising:
a touch panel driver receiving a coordinate signal for a position at which the first and second sensor electrodes are contacted with each other;
a plurality of signal lines connecting the contact electrodes to the touch panel driver.

3. The display device of claim 2, wherein the touch panel driver is loaded in a display panel driver for driving at least one of a gate line or a data line on the second substrate.

4. The display device of claim 2, wherein the touch panel driver is loaded on a printed circuit board connected to the second substrate via a flexible circuit film.

5. The display device of claim 1, wherein the third substrate comprises one selected from the group consisting of an optical film, a polarizing plate, and a glass substrate.

6. The display device of claim 1, wherein the short-circuit point comprises a conductive metal-based material containing at least one selected from the group consisting of Au and Ag.

7. The display device of claim 1, further comprising a spacer for maintaining a cell gap between the first and second sensor electrodes.

8. The display device of claim 1, wherein the sensor line comprises;
first and second sensor lines electrically connected to two opposing sides of the first sensor electrode, respectively;
third and fourth sensor lines electrically connected to remaining two opposing sides of the second sensor electrode not having the first and second sensor lines formed thereon, respectively; and
first and second auxiliary sensor lines on the third substrate to be electrically connected to the first and second sensor lines, respectively.

9. The display device of claim 8, wherein the contact electrode on the second substrate includes first, second, third, and fourth contact electrodes for supplying reference voltages to the first, second, third, and fourth sensor lines, respectively, and wherein the contact electrode on the third substrate includes fifth, sixth, seventh, and eighth contact electrodes connected to the third and fourth sensor lines and one end portions of the first and second auxiliary sensor lines to correspond to the first, second, third, and fourth contact electrodes, respectively.

10. The display device of claim 9, wherein the short-circuit point comprises first, second, third, and fourth short-circuit points electrically connecting the first, second, third, and fourth contact electrodes to the fifth, sixth, seventh, and eighth contact electrodes, respectively.

11. The display device of claim 1, wherein the sensor line comprises:
first, second, third, and fourth sensor lines electrically connected to the first sensor electrode of the first substrate; and
a fifth sensor line electrically connected to sides of the second sensor electrode of the third substrate.

12. The display device of claim 11, further comprising:
first, second, third, and fourth contact electrodes on the second substrate to supply reference voltages to the first, second, third, and fourth sensor lines, respectively;
fifth, sixth, seventh, and eighth contact electrodes on the third substrate to correspond to the first, second, third, and fourth contact electrodes, respectively;
a ninth contact electrode on the second substrate to externally supply a sensor signal from the fifth sensor line; and
a tenth contact electrode connected to the fifth sensor line of the third substrate to correspond to the ninth contact electrode.

13. The display device of claim 12, wherein the short-circuit point comprises:
first, second, third, and fourth short-circuit points electrically connecting the first, second, third, and fourth contact electrodes to the fifth, sixth, seventh, and eighth contact electrodes, respectively; and
a fifth short-circuit point electrically connecting the ninth and tenth contact electrodes.

14. The display device of claim 13, further comprising:
sixth, seventh, eighth, and ninth short-circuit points electrically connecting the fifth, sixth, seventh, and eighth contact electrodes to the first, second, third, and fourth sensor lines, respectively.

15. The display device of claim 11, further comprising a linear pattern on edges of the first sensor electrode to form an equal potential of the first sensor electrode.

16. A method of manufacturing a display device, comprising:
forming at least one contact electrode on a second substrate of a display panel having the second substrate and a first substrate opposing the second substrate;
forming a first sensor electrode on the first substrate;
forming a second sensor electrode on a third substrate opposing the first substrate;
forming a sensor line electrically connected to the first and second sensor electrodes of the first and third substrates;
forming a contact electrode on the third substrate to be electrically connected to the sensor line of the third substrate, wherein the contact electrode is configured to correspond to the contact electrode of the second substrate; and
forming a short-circuit point connecting together the corresponding contact electrodes of the second and third substrates.

17. The method of claim 16, the sensor line forming step comprising:
forming first and second sensor lines electrically connected to two opposing sides of the first sensor electrode of the first substrate, respectively;
forming first and second auxiliary sensor lines on the third substrate to correspond to the first and second sensor lines, respectively; and
forming third and fourth sensor lines electrically connected to remaining two opposing sides of the second sensor electrode except the two opposed sides having the first and second auxiliary sensor lines formed thereon.

18. The method, of claim 16, after the steps of forming the first and second sensor electrodes, the method further comprising forming a spacer for maintaining a cell gap between the first and second sensor electrodes.

19. The method of claim 16, the sensor line forming step comprising:
forming first, second, third, and fourth sensor lines connected to the first sensor electrode; and
forming a fifth sensor line connected to the second sensor-electrode.

20. The method of claim 19, wherein the fifth sensor line forming step further comprises forming the fifth sensor line along a periphery of the second sensor electrode to configure a closed loop.

21. The method of claim 19, after the first sensor electrode forming step, the method further comprising forming a linear pattern on edges of the first sensor electrode to form an equal potential of the first sensor electrode.
